(19) United States
(12) Patent Application Publication
(10) Pub. No.: US 2012/0154782 A1
(43) Pub. Date: Jun. 21, 2012

(54) Sighting Optics Device

(75) Inventors: Martin Sinner-Hettenbach, Rutesheim (DE); Oliver Wolst, Singapore (SG); Tatiana Babkina, Tuebingen (DE); Peter Wolf, Leinfelden-Echterdingen (DE)

(73) Assignee: Robert Bosch GmbH, Stuggart (DE)

(21) Appl. No.: 13/322,421

(22) PCT Filed: Mar. 29, 2010
(86) PCT No.: PCT/EP2010/054070

§ 371 Date: Mar. 8, 2012

(30) Foreign Application Priority Data
May 25, 2009 (DE) 10 2009 026 435.3

(51) Int. Cl. G01C 3/02; B21D 39/03; G02B 23/02

(52) U.S. Cl. 356/3; 359/431; 29/428

(57) ABSTRACT

The disclosure is based on an aiming optical device for a measuring instrument, more particularly for a distance measuring instrument comprising an optical unit, having at least one optical deflection unit and a first optical lens element. It is proposed that the optical deflection unit and the first optical lens element are embodied integrally with one another at least in part.

### PRIOR ART

The invention assumes a sighting optics device according to the preamble of claim 1.

A sighting optics device for a measuring instrument, with an optics unit has already been disclosed. The optics unit has an optical deflection unit and an optical lens element.

### DISCLOSURE OF THE INVENTION

The invention assumes a sighting optics device for a measuring instrument, more particularly for an electro-optical rangefinder, with an optics unit which has at least one optical deflection unit and a first optical lens element.

What is proposed is that the optical deflection unit and the first optical lens element at least in part have an integral design with one another.

In this context, a “sighting optics device” should in particular be understood to mean a device and/or a unit provided for aligning the measuring instrument, more particularly the rangefinder, in respect of a measurement object, such as e.g. a wall, and/or which allows a user to aim at a measurement object before a measuring procedure by means of the measuring instrument.

Moreover, an “optical deflection unit” should in particular be understood to mean a unit provided for deflecting a light and/or laser beam and/or precisely such a bundle of rays, with the deflection being made possible by means of reflection on reflection faces, such as e.g. mirror faces and/or prism faces, and/or by means of refraction of the incident beams, for example by means of a prism.

Here, the light beam and/or the bundle of rays can be formed by a beam and/or a bundle of rays from an image, such as e.g. an image of a measurement object. A beam direction of a beam and/or bundle of rays incident on the deflection unit differs from a beam direction of a beam and/or bundle of rays leaving the deflection unit, with an orientation of individual beams, in particular of the same wavelength, not changing with respect to one another within the bundle of rays before and after the deflection.

An “optical lens element” should in particular be understood to mean a refractive element. This may be an individual lens or else a group of lenses. To this end, the optical lens element has at least one, preferably two, light refracting faces, of which at least one is embodied as a curved face, more particularly a concave or convex curved face with a focal length, with the curved face affording the possibility of focusing the beams in particular onto a point or the beams diverging. The optical lens element can image an object in an enlarged or reduced fashion, or with unchanging dimensions.

“Integral” should in particular be understood to mean as formed by a single component and/or one-piece and/or by a single cast. The embodiment according to the invention of the sighting optics device advantageously allows a particularly compact sighting optics device to be achieved while saving further installation space, further components and costs. Moreover, this affords the possibility of obtaining advantageous matching, in respect of beam routing, between the optical deflection unit and the optical lens element during the design and/or production of the optics unit and the optical deflection unit can subsequently, in one work step, be assembled in a preset fashion together with the first optical lens element as a component in the measuring instrument, more particularly the laser rangefinder. It is particularly advantageous for the rangefinder to be formed by a laser rangefinder.

Advantageous deflection and/or diffraction of an incident beam, more particularly a light and/or laser beam, can be achieved if the optical deflection unit has a prism. Here, the optical deflection unit particularly advantageously has at least one pentaprism; more particularly, the prism is formed by the pentaprism, which allows a compact optics unit with advantageous beam routing to be achieved, with, in particular, complicated adjustment of individual components such as e.g. mirror faces being able to be dispensed with at least in part as a result of these having an integral design with the pentaprism.

It is furthermore proposed that the optical deflection unit is formed, at least in part, by an optical injection molded component. Here an “optical injection molded component” should in particular be understood to mean a light-conducting, at least partly transparent injection molded component that is particularly advantageously formed, at least in part, by a material with a transparent and nonpolar thermoplastic, such as e.g. the cycloolefin polymer Zeonex. As an alternative to this, the optical injection molded component can also comprise a transparent polycarbonate and/or a thermoplastic plastic, such as, in particular, a polymethyl methacrylate and/or further transparent materials deemed useful by a person skilled in the art.

The optical lens element is preferably integrated into the optical injection molded component and has an integral design, or an at least part-integral design, with the latter such that a compact optical component can be obtained, which can moreover be integrated into the measuring instrument in a simple structural fashion. In this context, part-integral means that at least one element of a multi-part optical lens element is integrated with or in the optical injection molded component in an integral fashion. A further possible achievement is that the optical lens element and/or further optical elements integrated in the optical deflection unit merely have to be set and/or adjusted once with respect to one another during the production of the optical injection molded component, and a subsequent and more particularly unwanted displacement of a component and/or an element out of a set position can advantageously be prevented. Moreover, it is possible to implement a particularly light and more particularly cost effective measuring instrument, and thus achieve high user friendliness.

It is furthermore proposed that the first optical lens element is formed, at least in part, by a positive lens. The positive lens preferably, at least in part, performs a function of an objective of the optics unit. As a result of this embodiment of the invention, the objective of the optics unit can, within the optics unit, be arranged in a space-saving and, more particularly, a fixedly adjusted fashion with respect to further optical elements of the optics unit, such as e.g. the optical deflection unit. Moreover, in principle it is feasible for the first optical lens element to be formed by a negative lens and/or an optical lens system.

It is furthermore proposed that the optics unit forms or acts as at least one concave mirror which is formed by the first optical lens element. Here, the optical lens element is particularly advantageously formed by a positive lens, the inner side of which or the side of which pointing to the center of the prism, at least in part, functions as a concave mirror. Here it is advantageously possible to achieve an advantageous combination of functions while saving further components, installation space, assembly time and costs. In particular, the light beam and/or the laser beam can, during a measurement, be partly reflected on the element serving as a concave mirror and thus be deflected in the direction of the operator and/or an eye of the operator as a target marker, while a measurement, more particularly a distance measurement, can be undertaken using the remaining partial beam.

In an advantageous development of the invention, it is proposed that the optics unit has at least a second optical lens element which has an integral or at least partly integral design with the optical deflection unit. It is possible to implement a particularly compact optics unit, which may be produced in advance and which can preferably be installed as an optical component during an assembly and/or production of the measuring instrument, more particularly the laser rangefinder, while saving further assembly steps. Moreover, both optical lens elements can in this case advantageously be matched to one another, with both optical lens elements having an in particular integral design with the optical injection molded component. An optical principal plane of the second optical lens element is preferably substantially perpendicular with respect to an optical principal plane of the first optical lens element.

The second optical lens element is particularly advantageously formed, at least in part, by a negative lens. The negative lens preferably at least partly functions as an eyepiece of the optics unit.

This embodiment of the invention makes it possible to realize an image of a measurement object according to a principle of a Galilean telescope, which preferably shows an upright and, more particularly, enlarged image of the measurement object and so it is possible to obtain good readability and/or orientation of an aimed-at measurement point for the user. However, in principle, it is feasible for the second optical lens element to be formed by a positive lens and/or an optical lens system. The first optical lens element and the second optical lens element are preferably set and/or arranged with respect to one another such that a focused image is generated in the eye of an operator, more particularly on his retina, which is particularly advantageously independent of a distance between the eye and one of the optical lens elements, more particularly the second optical lens element.

In an alternative embodiment of the invention, it is proposed that the optics unit has at least one coating which is arranged on or in at least one surface of the optical deflection unit. Here, a “coating” should in particular be understood to mean a layer applied on or in a surface of the optical deflection unit, with material properties of the applied layer preferably differing from material properties of the optical deflection unit. The coating is preferably directed to a function of the surface within the optical deflection unit, such as e.g. an at least partly dielectric coating for a surface embodied as a mirroring or reflecting face. Moreover, the coating can be formed, at least in part, by further, more particularly metallic materials such as e.g. a silver material.

As a result of this embodiment of the invention and, more particularly, by means of a dielectric coating, it is advantageously possible to modify an optical property of the surface of the optical deflection unit; in particular, it is possible here for a refractive index of the coating to differ from a refractive index of the optical deflection unit and/or a filter property for light beams incident on or emerging from the optical deflection unit may be modified by the coating. Moreover, the various surfaces of the optical deflection unit can be provided with different coatings, for example with a mirroring coating for generating mirroring faces or mirror faces, a dielectric coating for a partial reflection of the light beam, more particularly the laser beam, on the coated face, etc. The individual coated surfaces can moreover differ in terms of a layer thickness of the coating and so it is possible for different optical properties, such as e.g. different transmission properties for light and/or laser radiation, to be generated in the case of the same coating material. Moreover, a dielectric coating can be applied quantitatively with high process reliability to the face to be coated.

Furthermore, it is proposed that a coating at least in part forms a mirroring face of the optical deflection unit, which can in a structurally simple fashion implement the sighting optics device while saving further components, installation space and costs. In particular, this can achieve advantageous matching between the mirroring face and further components and/or elements of the optical deflection unit, such as further mirroring faces in particular, and/or of the first and/or second optical lens element, and subsequent adjustment can advantageously be prevented and saved.

It is proposed that at least two mirroring faces of the optical deflection unit include an angle of substantially 45° with respect to one another, even if these faces do not have a common vertex or a common vertex line. In the process, this can bring about advantageous beam guidance of the light beam and/or the laser beam from the objective, which is embodied as a positive lens, to the eyepiece, which is embodied as a negative lens and aligned substantially perpendicular to the objective. In particular, this can bring about a sighting optics device according to Galileo's principle with an enlarged and, in particular, upright image.

The optical lens element embodied as a positive lens particularly advantageously has an at least partly mirroring and/or reflecting coating on one surface and/or a transmission property of a lens surface can be reduced by means of the coating such that the positive lens together with the coating at least in part has the functionality of a concave mirror for light and/or laser radiation, which are incident on the positive lens from a direction proceeding from a center point of the optical deflection unit. Reflection of light and/or laser beams on the concave mirror element can in this case be dependent on an angle of incidence of the light and/or laser beams incident on the inner face of the positive lens and/or dependent on the wavelength thereof.

In an advantageous development of the invention it is proposed that the sighting optics device has at least one further optical element, more particularly an element embodied as an injection molded component, which is provided for coupling light and/or laser beams into the deflection unit. The further optical element is preferably made of the same material as at least part of a material of the deflection unit, more particularly of the first optical injection molded component. In this context “coupling light into” should in particular be understood to mean that the further optical injection molded component can introduce radiation, more particularly light and/or laser radiation, into the first optical injection molded component for illuminating the latter, such that advantageous visibility is provided for a user. The coupled-in light radiation moreover preferably forms a reference mark for aiming at a measurement object.

Furthermore, it is proposed that a transmission-reflection layer is, at least in part, arranged between the deflection unit and the further optical element. Here, a “transmission-reflection layer” should in particular be understood to mean a layer that has a reflection effect along a direction for light and/or laser radiation incident on the layer and has a transmission effect along a preferably opposing direction for light and/or laser radiation incident on the layer. The transmission-reflection layer is preferably formed by a dielectric material and arranged on a boundary between the deflection unit and the further optical element, with the deflection unit and the further optical element more particularly being arranged directly adjacent to one another. In principle, it is also feasible for the transmission-reflection layer to be formed by an adhesive used to bond the deflection unit to the further optical element. Here it is possible to achieve an advantageous combination of functions by having a transition between the deflection unit and the further optical injection molded component to be substantially transparent to radiation coupling into the deflection unit and to be substantially impermeable or reflecting for radiation incident on the transmission-reflection layer from an interior of the deflection unit.

In particular, the further optical element has a face that is parallel to a face of the deflection element and/or of the first lens element.

It is furthermore proposed that the sighting optics device has at least one radiation source for generating radiation provided for measuring the distance to and aiming at a measurement object, as a result of which it is advantageously possible to save further components, installation space, assembly complexity and costs. Here the radiation source can be formed by a laser radiation source and/or a light radiation source, such as e.g. an LED, with the radiation source more particularly being provided for emitting visible radiation. The radiation coupled into the deflection unit in the process is preferably used at least in part for a measurement operation and the remaining radiation is used to aim at the measurement object, with the remaining radiation more particularly forming a visible radiation spot such as e.g. a visible laser spot.

Moreover, the invention assumes a rangefinder, more particularly a laser rangefinder, with at least one sighting optics device. Here, a particularly space-saving and more particularly compact design of the laser rangefinder can be achieved and thus an increase in user friendliness of the laser rangefinder can be achieved.

Furthermore, the invention assumes an assembly method for a rangefinder with a sighting optics device, with, in a first step, a deflection unit being produced together with a first and/or a second optical lens element and the component being subsequently assembled in the rangefinder. In one embodiment of the production method according to the invention, a deflection unit is produced together with a first and/or a second optical lens element in a first step, the deflection unit is assembled to form a component together with a further optical element, more particularly an injection molded component serving for coupling into the deflection unit, in a second step, and subsequently the component is assembled in the rangefinder.

In one embodiment of the production method according to the invention, a deflection unit is produced together with a first and/or a second optical lens element in a first step, the deflection unit is assembled to form a component together with a further optical element, more particularly an injection molded component serving for coupling into the deflection unit, in a second step, and subsequently this component is assembled in the rangefinder.

In one embodiment of the production method according to the invention, a deflection unit is produced together with a first and/or a second optical lens element in a first step, the deflection unit is assembled to form a component together with further optical elements, more particularly an injection molded component serving for coupling into the deflection unit and/or a light source, more particularly a laser light source, and/or an adjustment apparatus, in a second step, and subsequently this component is assembled in the rangefinder.

Here it advantageously is possible to achieve a structurally simple assembly of the rangefinder while saving production times and costs. Moreover, it is possible to achieve particularly advantageous and simple adjustment of the sighting optics device before assembling the rangefinder.

Here “a component” should in particular be understood to mean an individual component.

### DRAWING

Further advantages emerge from the following description of the drawing. An exemplary embodiment of the invention is illustrated in the drawing. The drawing, the description and the claims contain a number of features in combination. A person skilled in the art will expediently also consider the features individually and combine these to form meaningful further combinations.

In detail:

FIG. 1 shows a schematic illustration of a measuring instrument with a sighting optics device,

FIG. 2 shows a schematic illustration of the sighting optics device together with a radiation source, formed separately from the sighting optics device, for measuring distance,

FIG. 3 shows a detailed view of the sighting optics device and

FIG. 4 shows a detailed view of an alternative embodiment of the sighting optics device.

### DESCRIPTION OF THE EXEMPLARY EMBODIMENTS

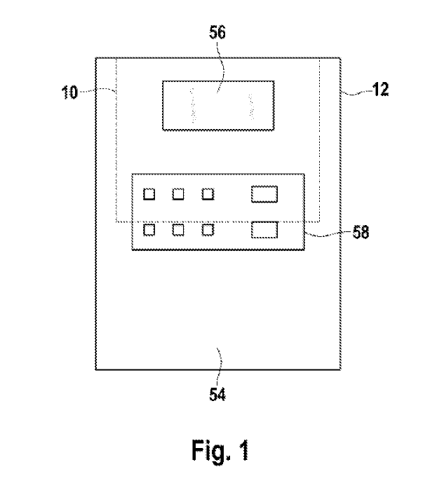

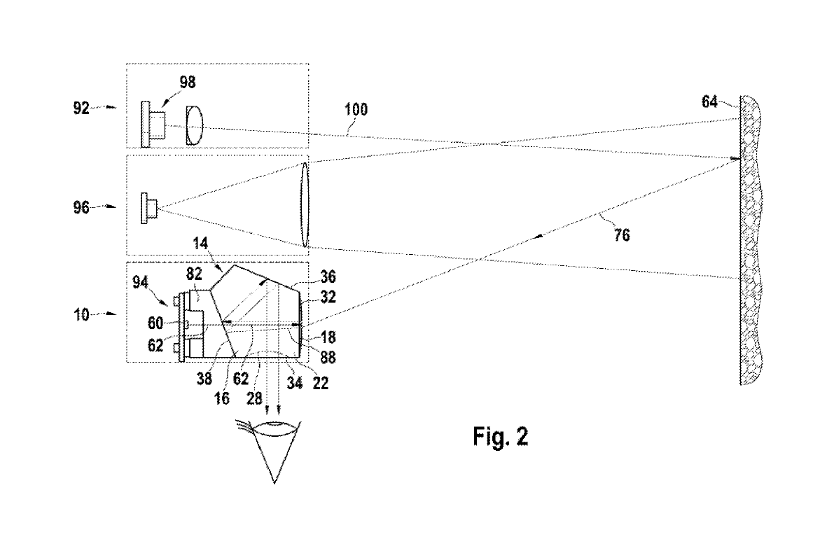

FIG. 1 illustrates a measuring instrument formed by a rangefinder 12, which has a sighting optics device 10 that is surrounded by a casing 54 of the rangefinder 12. Here the rangefinder 12 is formed by a laser rangefinder. Moreover, the laser rangefinder has a display unit 56, which is provided for outputting a measurement result during operation of the laser rangefinder, and an input unit 58 with a plurality of input buttons, which are provided for operating the laser rangefinder by an operator. FIG. 2 schematically illustrates a design of the laser rangefinder with a transmitter unit 92, a detection unit 96 and a sighting optics device 10. The transmitter unit 92 has a first radiation source 98, which is formed by a laser radiation source such as e.g. a laser diode which is provided for generating a laser beam 100 for measurement operation (FIG. 2). During the measurement operation, the laser beam 100 is directed at an aimed-at measurement object 64, for example a wall surface, and a distance between the laser rangefinder and the measurement object 64 is calculated on the basis of the beam reflected by the measurement object 64 and received by the laser rangefinder by means of the detection unit 96.

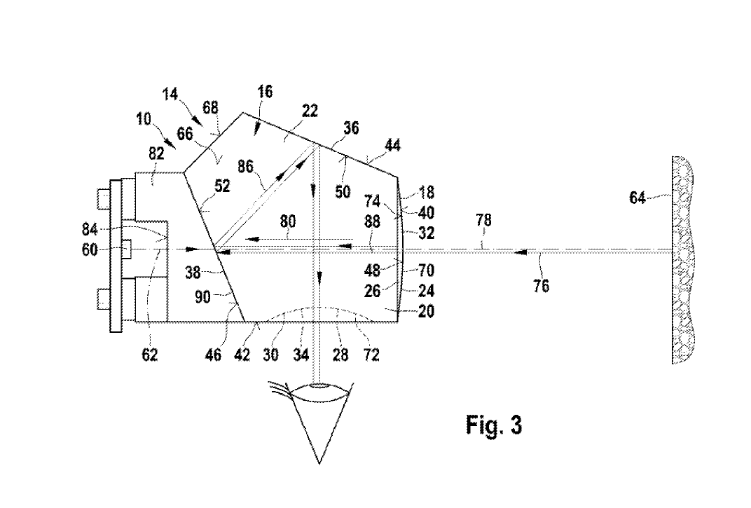

The sighting optics device 10 of the laser rangefinder 12 is illustrated in more detail in FIGS. 2 and 3. The sighting optics device 10 comprises an optics unit 14 which has an optical deflection unit 16 and a first optical lens element 18, with the optical deflection unit 16 in the process having an integral design with the first optical lens element 18. Moreover, the optics unit 14 has a second optical lens element 28, which likewise has an integral design with the optical deflection unit 16 (FIG. 3). However, in principle it is also feasible for the second optical lens element 28 to have a separate embodiment from the optical deflection unit 16 or to consist of a plurality of lenses, a subset of which being embodied separately from the optical deflection unit 16. An analog statement also holds true for the first optical lens element 18.

The optical deflection unit 16 is formed by an optical injection molded component 22 together with the first optical lens element 18 and the second optical lens element 28, which injection molded component is preferably made of a material with a transparent and nonpolar thermoplastic, such as e.g. the cycloolefin polymer Zeonex. However, alternatively it is also feasible that the first optical lens element 18 and/or the second optical lens element 28 are formed, at least in part, by a material that differs from the material of the optical deflection unit 16, more particularly the optical injection molded component 22, and the first optical lens element 18 and/or the second optical lens element 28 is/are integrated into the optical deflection unit 16, more particularly the optical injection molded component 22, by at least partial insert molding.

The optical deflection unit 16 comprises a prism formed by a pentaprism 20, with the pentaprism 20 having a pentagonal and/or five-sided cross-sectional area 66. The pentaprism 20 comprises a first surface 40 and a second surface 42, which are arranged directly adjoining one another and/or directly neighboring one another. The first and the second surface 40, 42 are arranged substantially perpendicular to one another. The pentaprism 20 furthermore has a third surface 44, which likewise directly adjoins the first surface 40, with the first and third surfaces 40, 44 including an angle of greater than 90° with respect to one another. A fourth surface 46 of the pentaprism 20 directly adjoins the second surface 42, with the second and fourth surfaces 42, 46 including an angle of greater than 90° with respect to one another. The third and fourth surfaces 44, 46 moreover form an angle of substantially 45° with respect to one another. A fifth surface 68 of the pentaprism 20 is arranged between the third and fourth surfaces 44, 46.

The first optical lens element 18 and the second optical lens element 28 are respectively arranged on one surface 40, 42 of the optical deflection unit 16, more particularly of the pentaprism 20, with the first optical lens element 18 being arranged on the first surface 40 and the second optical lens element 28 being arranged on the second surface 42 of the pentaprism 20. The first optical lens element 18 is formed by a positive lens 24, which is embodied as an objective 70 of the optics unit 14, with a convex arc of the positive lens 24 being arranged on an external face of the optical deflection unit 16, more particularly of the pentaprism 20. The second optical lens element 28 is formed by a negative lens 30, which is embodied as an eyepiece 72 of the optics unit 14. Hence the positive lens 24 and the negative lens 30 are arranged substantially perpendicular to one another. The negative lens 30 has a concave arc, which is likewise arranged on an external face of the optical deflection unit 16, more particularly of the pentaprism 20.

Moreover, the optics unit 14 has a plurality of coatings 32, 34, 36, 38 which are arranged on the various surfaces 40, 42, 44, 46 of the deflection unit 16. An at least partly mirroring and/or reflecting coating 32 is applied to a portion of the first surface 40 comprising the convex arc, which coating has a mirroring and/or reflecting effect and/or an at least transmission-reducing effect for light and/or laser beams 62, which are incident on an inner side 74 of a lens face of the positive lens 24 and/or on the coating 32 from an interior of the optical deflection unit 16. The positive lens 24 thus acts as a concave mirror 26 with a mirroring face 48 for light and/or laser beams incident on the inner side while the coating 32 substantially transmits radiation that is incident on the convex arc from the outside. The coating 32 is matched to a wavelength of the laser beam 62 such that transmission of the laser beam 62 through the concave mirror 26 is reduced and there is an at least partial reflection of the laser beam 62 on the concave mirror 26. Here the coating 32 is formed by a dielectric coating. In an alternative embodiment of the sighting optics device 10, it is moreover feasible to dispense with a coating 32, 34, 36, 38 of the surfaces 40, 42, 44, 46 of the deflection unit 16.

A mirroring and/or reflective coating 36, 38 is likewise applied to the third surface 44 and the fourth surface 46 such that light and/or laser beams 62, which are incident on the coating 36, 38 from the interior of the optical deflection unit 16, are likewise reflected and/or mirrored at the two surfaces 44, 46. The third and fourth surface 44, 46 is respectively embodied as a mirroring face 50, 52, with the two mirroring faces 50, 52 including an angle of substantially 45° with respect to one another. Here the two mirroring faces 50, 52 are embodied as flat mirrors. The mirroring and/or reflecting coating 36, 38 is in this case matched to a wavelength of the light and/or laser beam 62 running through the deflection unit 16, and so a mirroring and/or reflecting property of the coating is mainly brought about for this radiation. Moreover, at least the mirroring face 52 has a transmission property for radiation, more particularly laser radiation, that is incident on the coating 38 from outside of the optical deflection unit 16, and so this radiation can be coupled into the optical deflection unit 16 and the coating 38 is at least partly permeable to this radiation. By way of example, the coating 36, 38 is formed, at least in part, by a dielectric coating which, at least on the fourth surface 46, is at least in part formed by a transmission-reflection layer 90.

The second surface 42 of the optical deflection unit 16 likewise has a coating 34 which is formed by an anti-reflection coating, and so undesired reflection of light and/or laser radiation is advantageously prevented at the negative lens 30 and this affords a distortion-reduced or distortion-free view for the user by means of the eyepiece 72.

The first optical lens element 18 and the second optical lens element 28 are arranged with respect to the two surfaces 44, 46 embodied as mirroring faces 50, 52 or flat mirrors such that radiation that is incident on or emitted by an optical principal plane of the first optical lens element 18 in a substantially perpendicular fashion is mirrored and/or reflected by the fourth surface 46 or is incident on the latter and that radiation that is incident on or emitted by an optical principal plane of the second optical lens element 28 in a substantially perpendicular fashion is mirrored and/or reflected by the third surface 44 or is incident on the latter.

The deflection unit 16 with an integral design with the first and the second optical lens element 18, 28 is arranged within the sighting optics device 10 such that beams which from the outside, more particularly beams 76 which originate from the measurement object 64, are incident on the objective 70. Along an axis 78 that is aligned substantially perpendicular to the first surface 40 of the pentaprism 20 and extends from the positive lens 24 in a direction 80 of the fourth surface 46 of the optical deflection unit 16, a further optical element 82 is arranged after the fourth surface 46 and a radiation source 60 formed by a laser diode is arranged after said further optical element. The further optical element 82 is provided for coupling the laser beam 62 emitted by the radiation source 60 into the optical deflection unit 16. Moreover, the further optical element 82 is formed from the same material as the pentaprism 20, and so refraction of the laser beam 62 emitted by the radiation source 60 along the axis 78 is prevented between the further optical element 82 and the pentaprism 20 as a result of being the same optical media.

Arranged along the axis 78 there is a transmission-reflection layer 90 between the fourth surface 46 of the deflection unit 16 and the further optical element 82 such that the laser beam 62 emitted by the radiation source 60 is coupled into the deflection unit 16 during operation, but radiation is prevented from leaving the deflection unit 16 through the fourth surface 46. As an alternative to this, the transmission-reflection layer 90 can also be arranged on the further optical element 82 and/or be formed by an adhesive used to bond the deflection unit 16 to the further optical element 82. Moreover, it is always feasible to make an embodiment of the further optical element 82 using a different material to the pentaprism 20, with two adjoining faces of the further optical element 82 and the pentaprism 20 being able to include an angle of greater than 0° in order to achieve an effective coupling of the laser beam 62 into the pentaprism 20 and/or an irradiation angle of the laser beam 62 into the further optical element 82 and/or into the pentaprism 20 being able to be varied to this end.

During operation of the laser rangefinder, the laser beam 62 generated by the radiation source 60 is emitted by the radiation source 60 along the axis 78 in the direction of the optical deflection unit 16 and is firstly incident on a surface 84 of the further optical element 82 facing the radiation source 60. An angle of incidence of an optical axis of the laser beam 62 onto the surface 84 of the further optical element 82 is almost 90°, and so the laser beam 62 experiences no refraction and/or change in direction at the surface 84 and reflection of the laser beam 62 is virtually prevented and/or minimized.

A further lens element can be worked, more particularly in an integral fashion, into the further optical element 82 which serves for coupling into the deflection unit 16, for example for undertaking a beam adaptation of the beam 62.

In an alternative embodiment of the invention, it is moreover feasible that the laser beam 62 generated by means of the radiation source 60 only insufficiently illuminates the entire optics unit 14, and so a further optical lens element, which is more particularly formed by a negative lens, is arranged between the radiation source 60 and the further optical element 82 and provided for illuminating the entire optics unit 14.

Within the further optical element 82, which can more particularly be embodied as an injection molded part, the laser beam 62 is routed in the direction of the optical deflection unit 16. As a result of the fact that the optical deflection unit 16 is made of the optical injection molded component 22 and the coating 36 on the surface 46 transmits the laser beams 62, the laser beam 62 does not experience a deflection at the transition between the optical injection molded component 22 and the further optical element 82. Within the deflection unit 16, the laser beam 62 runs along the axis 78 in the direction of the positive lens 24 and is in part reflected along the axis 78 in the direction of the fourth surface 46 of the optical deflection unit 16 by the coating 32 on the first surface 40. This reflected laser beam 62 is used as target marker 86 and/or reference marker for aiming at the measurement object 64, with the target marker 86 being identifiable to the user as a visible, e.g. red, point and/or spot. Together with an imaging beam 88 of an aimed-at point of the measurement object 64, this target marker 86 is routed along the axis 78 in the direction of the fourth surface 46, which is formed by the mirroring face 52, with the imaging beam 88 being coupled into the optical deflection unit 16 by the positive lens 24. The target marker 86 is incident on the fourth surface 46 together with the imaging beam 88 and is reflected there as a result of the coating 38, with the angle of incidence equaling the angle of reflection in this case. The target marker 86 reflected on the fourth surface 46 and the imaging beam 88 are reflected on the fourth surface 46 in the direction of the third surface 44 and are likewise reflected by the latter as a result of the coating 36 and deflected in the direction of the negative lens 30. The two beams emerge, visible for a user, from the negative lens 30, with a focused image of the measurement object 64 and the reference marker being generated on the retina of the operator by means of the negative lens 30. There can be enlarged imaging according to the principle of a Galilean telescope by means of the positive lens 24 and the negative lens 30 together with the two mirroring faces 50, 52 embodied as flat mirrors.

The sighting optics device 10 together with the radiation source 60 is embodied as one component, which can be installed into the laser rangefinder in a structurally simple fashion and more particularly saving further assembly steps during a production process of the laser rangefinder, wherein, during an assembly process, the deflection unit 16 formed by the pentaprism 20 is first of all produced together with the two optical lens elements 18, 28 by injection molding and the coatings 32, 34, 36, 38 are applied to the deflection unit 16 and/or the further optical element 82 and the deflection unit 16 is subsequently assembled to form a component 94 with the further optical element 82 and/or the radiation source 60. In the process, the sighting optics device 10 is adjusted by matching the optical deflection unit 16 and the further optical element 82 and/or the radiation source to one another. Subsequently the preassembled and matched component 94 is assembled in the rangefinder 12.

Moreover, in an alternative embodiment of the invention, it is always feasible for the target marker 86 to be embodied in the form of an overlaid crosshair and/or in the form of further target markers 86 deemed useful by a person skilled in the art.

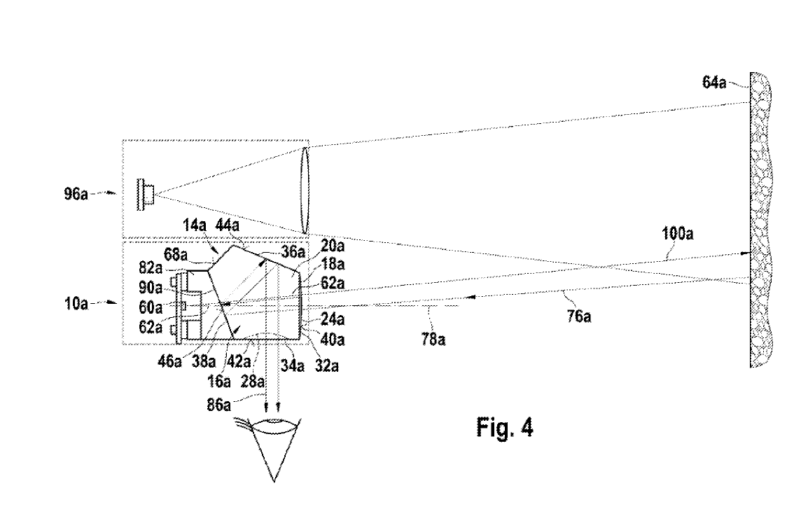

FIG. 4 illustrates an alternative embodiment of a rangefinder 12 to the one in FIGS. 2 and 3. Substantially unchanging components, features and functions are in principle labeled by the same reference sign. In order to distinguish between the exemplary embodiments, the letter a has been appended to the reference signs of the following exemplary embodiment. The subsequent description is substantially restricted to the differences from the exemplary embodiment in FIGS. 2 and 3, with it being possible for reference to be made to the description of the exemplary embodiment in FIGS. 2 and 3 in respect of unchanging components, features and functions.

Compared to the laser rangefinder from FIGS. 2 and 3, the rangefinder 12a formed by a laser rangefinder according to FIG. 4 only has a single radiation source 60a, which is provided both for generating radiation, which is used for a distance measurement and for aiming at a measurement object 64a during operation. Here the radiation source 60a is formed by a laser diode. The radiation is formed by a laser beam 62a, which has both the function of a laser beam 100a embodied for a distance measurement and the function of a target marker 86a for aiming at the measurement object 64a.

The sighting optics device 10a as per FIG. 4 has an optical deflection unit 16a, which is formed by a pentaprism 20a and has at least one coating 38a formed, at least in part, by a transmission-reflection layer 90a. This coating 38a is arranged on a fourth surface 46a, facing the radiation source 60a, of the optical deflection unit 16a. This coating 38a filters out a component of the laser light, and so the laser beam 62a enters the optical deflection unit 16a with reduced intensity. This reduced intensity of the laser beam 62a allows the use of a conventional laser source as a radiation source 60a, without having to worry about a risk to the operator when observing the target marker 86a. A component of the laser beam 62a, which runs along an axis 78a in the direction of a first optical lens element 18a formed by a positive lens 24a, is in part reflected substantially along the axis 78a in the direction of the fourth surface 46a of the optical deflection unit 16a by a coating 32a on a first surface 40a of the deflection unit 16a, with the coating 32a having both a transmission property and a reflection property such that a partial beam of the laser beam 62a leaves the deflection unit 16a through the positive lens 24a and a partial beam of the laser beam 62a is reflected by the coating 32a. This reflected component of the laser beam 62a is used as target marker 86a and/or reference marker for aiming at the measurement object 64a. A component of the laser beam 62a, which leaves the deflection unit 16a in the direction of the measurement object 64a through the positive lens 24a, serves as laser beam 100a provided for measuring the distance.

1. A sighting optics device for a measuring instrument, more particularly for a rangefinder, comprising:
an optics unit which has at least one optical deflection unit and a first optical lens element,
wherein the optical deflection unit and the first optical lens element at least in part have an integral design with one another.

2. The sighting optics device as claimed in claim 1, wherein:
the optical deflection unit has at least one prism, more particularly and the at least one prism is a pentaprism.

3. The sighting optics device as claimed in claim 1, wherein the optical deflection unit is formed, at least in part, by an optical injection molded component.

4. The sighting optics device as claimed in claim 1, wherein the first optical lens element is formed, at least in part, by a positive lens.

5. The sighting optics device as claimed in claim 1, wherein the optics unit forms at least one concave minor which is formed, at least in part, by the first optical lens element.

6. The sighting optics device as claimed in claim 1, wherein the optics unit has at least a second optical lens element which, at least in part, has an integral design with the optical deflection unit.

7. The sighting optics device as claimed in claim 6, wherein the second optical lens element is formed, at least in part, by a negative lens.

8. The sighting optics device as claimed in claim 1, wherein the optics unit has at least one coating which is arranged on or in at least one surface of the optical deflection unit.

9. The sighting optics device as claimed in claim 8, wherein the coating at least in part forms a mirroring face of the optical deflection unit.

10. The sighting optics device as claimed in claim 1, wherein the optical deflection unit has at least two mirroring faces, which include an angle of substantially 45° with respect to one another.

11. The sighting optics device as claimed in claim 1, wherein:
the optics unit further includes at least one further optical element configured to couple light and/or laser beams into the deflection unit,
wherein the further optical element is an injection molded component.

12. The sighting optics device as claimed in claim 11, wherein a transmission-reflection layer is, at least in part, arranged between the deflection unit and the further optical element.

13. The sighting optics device as claimed in claim 1, further comprising:
at least one radiation source for generating radiation provided for measuring the distance to and/or aiming at a measurement object.

14. A rangefinder, more particularly a laser rangefinder, comprising:
at least one sighting optics device,
wherein the sighting optics device includes an optics unit which has at least one optical deflection unit and a first optical lens element, and
wherein the optical deflection unit and the first optical lens element at least in part have an integral design with one another.

15. An assembly method for a laser rangefinder, comprising:
producing at least one optical deflection unit as an integral component, together with a first and/or a second optical lens element; and
assembling this component in the laser rangefinder,
wherein the laser rangefinder includes at least one sighting optics device,
wherein the sighting optics device includes an optics unit,
wherein the optics unit includes the optical deflection unit and the first and/or the second optical lens element, and
wherein the optical deflection unit and the first optical lens element at least in part have an integral design with one another.
